(19) United States
(12) Patent Application Publication
(10) Pub. No.: US 2024/0134010 A1
(43) Pub. Date: Apr. 25, 2024

(54) OPTICAL SENSING DEVICE, OPTICAL SENSING SYSTEM, ANDOPTICAL SENSING METHOD

(71) Applicant: NEC Corporation, Tokyo (JP)

(72) Inventor: Katsuhiro YUTANI, Tokyo (JP)

(73) Assignee: NEC Corporation, Tokyo (JP)

(21) Appl. No.: 18/483,954

(22) Filed: Oct. 9, 2023

(30) Foreign Application Priority Data
Oct. 18, 2022 (JP) 2022-167775

(51) Int. Cl. G01S 7/48; G01N 21/88; G01S 17/88

(52) U.S. Cl. CPC G01S 7/4802; G01N 21/8851; G01S 17/88

(57) ABSTRACT

An optical sensing device includes a first point cloud data acquisition unit for acquiring first point cloud data associated with a first object and a second object that are included in a first region, a region specification unit for specifying a second region associated with the first object in the first region, a second point cloud data acquisition unit for acquiring second point cloud data associated with the first object by emitting second laser light from the light source to a plurality of second positions associated with the second region, based on second laser reflection light being reflection light of the second laser light, and a first abnormality detection unit for detecting abnormality of the first object, by using the second point cloud data.

This application is based upon and claims the benefit of priority from Japanese Patent Application No. 2022-167775, filed on Oct. 19, 2022, the disclosure of which is incorporated herein in its entirety by reference.

### TECHNICAL FIELD

The present disclosure relates to an optical sensing device and the like that detect abnormality by sensing using light.

### BACKGROUND ART

In general, a system using a technique referred to as light detection and ranging (LiDAR) enables measurement of a distance to a target and conversion of a shape of the target into point cloud data to be represented by a three-dimensional space. The point cloud data are used for measuring a physical surface shape of a structure of the target.

Japanese Unexamined Patent Application Publication No. 2020-203634 discloses a monitoring device including an optical measurement unit that emits laser forward in a course and measures reflection light and a processing unit that determines presence or absence of an obstacle forward in the course, based on a measurement result by the optical measurement unit. In the technique described in Japanese Unexamined Patent Application Publication No. 2020-203634, the processing unit sets a scanning range and scanning arrangement of the optical measurement unit according to a moving speed of a vehicle and a shape of the course.

Further, Japanese Unexamined Patent Application Publication No. 2018-180181 discloses a control unit that controls a scanning element in such a way as to change a size of a scanned region for which scanning is performed with laser light and density of dots on the scanned region to which the laser light is transmitted.

When a steel material (for example, H-shaped steel) or the like used for, for example, a railroad track or a building is inspected by LiDAR, such an inspection target has an important function as a frame of a structure or a rail on which a train travels, and therefore, the LiDAR system is required to efficiently detect abnormality of the inspection target. However, with the techniques described in Japanese Unexamined Patent Application Publication No. 2020-203634 and Japanese Unexamined Patent Application Publication No. 2018-180181, even though presence or absence of an obstacle may be detected, it is difficult to detect abnormality of an inspection target.

### SUMMARY

An example object of the disclosure has been made in view of the above-mentioned problem, and an object of the disclosure is to provide an optical sensing device and the like that are capable of efficiently detecting abnormality of an inspection target.

An optical sensing device according to an example aspect of the disclosure includes a first point cloud data acquisition means for acquiring first point cloud data associated with a first object and a second object that are included in a first region, based on first laser reflection light being reflection light of first laser light emitted from a light source configured to emit laser light to a plurality of first positions in the first region, a region specification means for specifying a second region associated with the first object in the first region, by using the first point cloud data, a second point cloud data acquisition means for acquiring second point cloud data associated with the first object by emitting second laser light from the light source to a plurality of second positions associated with the second region, based on second laser reflection light being reflection light of the second laser light, and a first abnormality detection means for detecting abnormality of the first object, by using the second point cloud data.

An optical sensing system according to an example aspect of the disclosure includes a light emission means for emitting first laser light to a plurality of first positions in a first region, a light reception means for receiving first laser reflection light being reflection light of the first laser light, a first point cloud data acquisition means for acquiring first point cloud data associated with a first object and a second object that are included in the first region, based on the first laser reflection light, a region specification means for specifying a second region associated with the first object in the first region, by using the first point cloud data, a second point cloud data acquisition means, and a first abnormality detection means, wherein the light emission means emits second laser light to a plurality of second positions associated with the second region, the light reception means receives second laser reflection light being reflection light of the second laser light, the second point cloud data acquisition means acquires second point cloud data associated with the first object, based on the second laser reflection light, and the first abnormality detection means detects abnormality of the first object, by using the second point cloud data.

An optical sensing method according to an example aspect of the disclosure includes emitting first laser light to a plurality of first positions in a first region, receiving first laser reflection light being reflection light of the first laser light, acquiring first point cloud data associated with a first object and a second object that are included in the first region, based on the first laser reflection light, specifying a second region associated with the first object in the first region, by using the first point cloud data, emitting second laser light to a plurality of second positions associated with the second region, receiving second laser reflection light being reflection light of the second laser light, acquiring second point cloud data associated with the first object, based on the second laser reflection light, and detecting abnormality of the first object, by using the second point cloud data.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration example of an optical sensing device according to a first example embodiment of the present disclosure;

FIG. 2 is a diagram illustrating details of the optical sensing device according to the first example embodiment of the present disclosure;

FIG. 3 is a diagram illustrating details of the optical sensing device according to the first example embodiment of the present disclosure;

FIG. 4 is a diagram illustrating details of the optical sensing device according to the first example embodiment of the present disclosure;

FIG. 5 is a flowchart illustrating an operation example of the optical sensing device according to the first example embodiment of the present disclosure;

FIG. 6 is a block diagram illustrating a configuration example of a modification example of the first example embodiment of the present disclosure;

FIG. 7 is a block diagram illustrating a configuration example of an optical sensing system according to a second example embodiment of the present disclosure;

FIG. 8 is a flowchart illustrating an operation example of the optical sensing system according to the second example embodiment of the present disclosure; and

FIG. 9 is a diagram illustrating an example of an information processing device for achieving the optical sensing device and the like according to the first and the second example embodiments of the present disclosure.

### EXAMPLE EMBODIMENT

With reference to the drawings, preferred example embodiments of the present disclosure are described in detail.

### First Example Embodiment

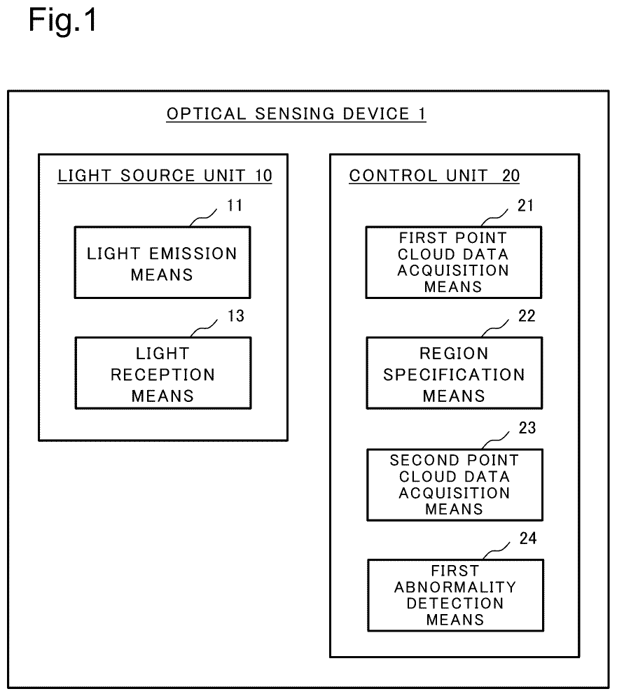

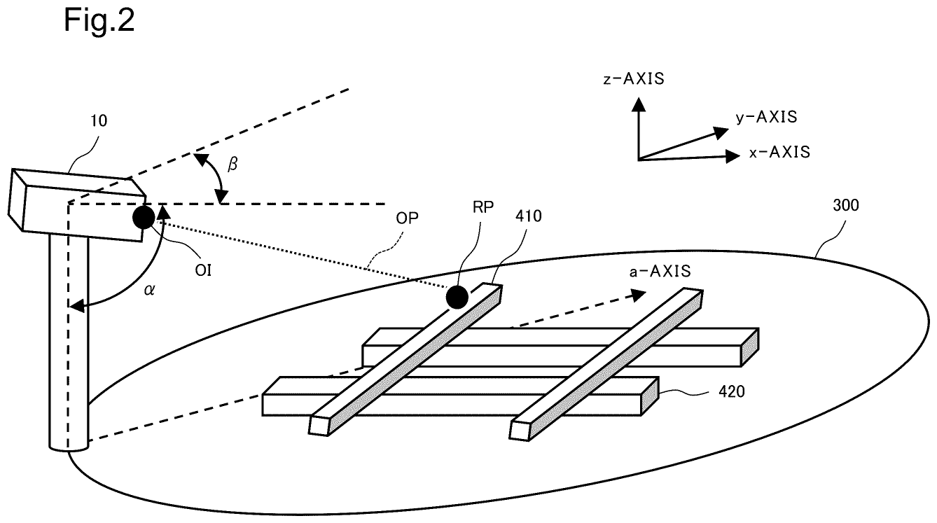

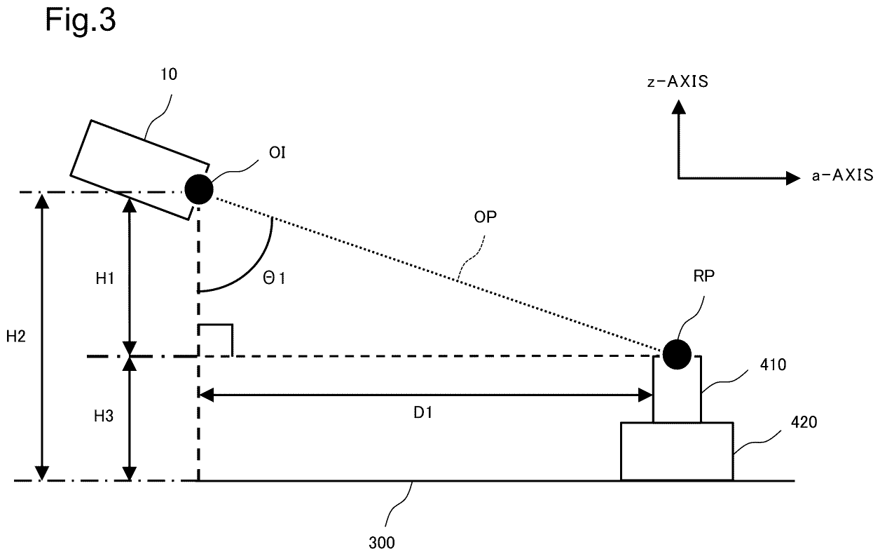

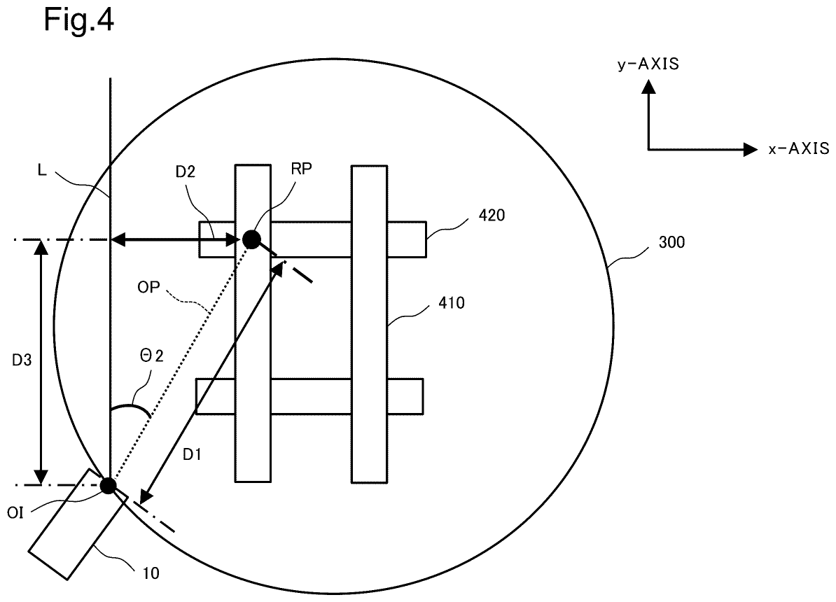

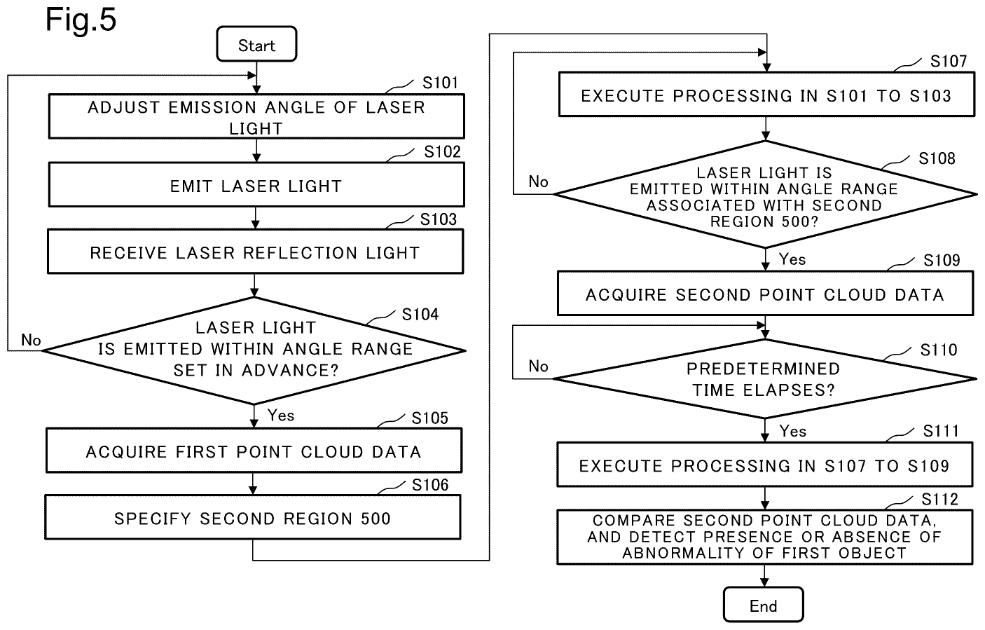

With reference to FIG. 1, FIG. 2, FIG. 3, FIG. 4, and FIG. 5, an optical sensing device 1 according to a first example embodiment is described. FIG. 1 is a block diagram illustrating a configuration example of the optical sensing device 1. FIG. 2, FIG. 3, and FIG. 4 are diagrams for describing details of the optical sensing device 1. FIG. 5 is a flowchart for describing an operation example of the optical sensing device 1.

A configuration of the optical sensing device 1 is described. The optical sensing device 1 includes a light source unit 10 and a control unit 20. Note that, in FIG. 1, the light source unit 10 and the control unit 20 are provided in an integrated manner, but may be separate units. In such a case, only the control unit 20 is included in the optical sensing device 1, and the light source unit 10 is not included in the optical sensing device 1. The light source unit 10 and the control unit 20 are mutually communicable via a communication means, which is not illustrated.

The light source unit 10 includes a light emission means 11 and a light reception means 13. For example, the light source unit 10 is attached to a stationary object. Examples of the stationary object include a ground surface and a building.

The light emission means 11 emits first laser light to a plurality of first positions in a first region 300. Specifically, the laser light is pulsed laser light. For example, as illustrated in FIG. 2, FIG. 3, and FIG. 4, the light emission means 11 emits the laser light from a light input/output end OI provided to the light source unit 10. With this, the emitted laser light propagates along an optical path OP, and enters a reflection point RP of a first object 410 present in the first region 300. The optical path OP is a line segment connecting the light input/output end OI and the reflection point RP to each other.

Further, as illustrated in FIG. 2, FIG. 3, and FIG. 4, in the first region 300, the first object 410 and a second object 420 are arranged. The light emission means 11 emits the first laser light into the first region 300, and hence the first laser light enters both the first object 410 and the second object 420. In other words, the plurality of first positions to which the first laser light is emitted includes positions at which the first object 410 and the second object 420 are arranged.

Herein, the first object 410 is a track of a railway line. Further, as illustrated in FIG. 2, FIG. 3, and FIG. 4, the second object 420 is provided under the first object 410. The second object 420 is a roadbed of the railway line, for example. Further, the first object 410 includes a track of the railway line. Further, the second object 420 includes a roadbed of the railway line.

Further, the light reception means 13 receives first laser reflection light being reflection light of the first laser light. Specifically, the light reception means 13 receives the first laser reflection light reflected at the first position in the first region 300. For example, in the example of FIG. 2, FIG. 3, and FIG. 4, the light reception means 13 receives the laser reflection light from the reflection point RP on the first object 410, via the optical path OP and the light input/output end OI. Further, as described later, a direction in which the light source unit 10 emits the laser light is changed, and thus the light reception means 13 is capable of receiving laser reflection light from different reflection points RP.

Next, the control unit 20 is described. As illustrated in FIG. 1, the control unit 20 includes a first point cloud data acquisition means 21, a region specification means 22, a second point cloud data acquisition means 23, and first abnormality detection means 24.

The first point cloud data acquisition means 21 is described. The first point cloud data acquisition means 21 generates first point cloud data indicating a three-dimensional model of the first region 300, based on the first laser reflection light received by the light reception means 13. The three-dimensional model is an aggregate of points whose positions are uniquely determined by a coordinate on an x-axis, a coordinate on a y-axis, and a coordinate on a z-axis. The first object 410 and the second object 420 are provided in the first region 300, and hence the first point cloud data include point clouds indicating the first object 410 and the second object 420. In other words, the first point cloud data acquisition means 21 acquires the first point cloud data associated with the first object 410 and the second object 420 that are included in the first region 300, based on the first laser reflection light.

Herein, with reference to FIG. 2, FIG. 3, and FIG. 4, details of a point cloud data generation method are described. FIG. 2 illustrates a positional relationship between the light source unit 10 and the first region 300 with the x-axis, the y-axis, and the z-axis. Further, FIG. 3 illustrates a positional relationship between the light source unit 10 and the first region 300 with the z-axis and an a-axis. The a-axis is acquired by projecting the optical path OP orthogonally on an x-y plane.

The light source unit 10 is tilted along an a direction (a vertical direction with respect to the x-y plane) illustrated in FIG. 2, and thus the light emission means 11 is capable of emitting the laser light at a freely selected angle θ1 as illustrated in FIG. 3. For example, as illustrated in FIG. 3, the angle θ1 is an angle formed of the optical path OP and a linear line of the laser light extending vertically downward from the light input/output end OI. The first point cloud data acquisition means 21 is capable of detecting the angle θ1 with a gyro sensor or the like, which is not illustrated.

When the z-coordinate of the reflection point RP included in the three-dimensional model is specified, the first point cloud data acquisition means 21 acquires a length of the optical path OP, based on a time from emittance of the laser light from the light emission means 11 to reception of the laser reflection light by the light reception means 13 (hereinafter, referred to as a time t). Specifically, the length of the optical path OP is acquired by multiplying the time t by a light speed and dividing the resultant value by two. The first point cloud data acquisition means 21 is capable of calculating a difference between the z-coordinate of the light input/output end OI of the laser light and the z-coordinate of the reflection point RP of the laser light (H1 in FIG. 3) by multiplying the length of the optical path OP by cos θ1. With this, the first point cloud data acquisition means 21 acquires a z-axis relative position of the reflection point RP with respect to the light input/output end OI.

Moreover, the first point cloud data acquisition means 21 calculates a length of a line segment D1 of the optical path OP projected on the x-y plane, by multiplying the length of the optical path OP by sin OI. As illustrated in FIG. 4, the line segment D1 is a line segment connecting from the light input/output end OI of the laser light to the reflection point RP on the x-y plane.

The light source unit 10 is tilted along a β direction (a parallel direction with respect to the x-y plane) illustrated in FIG. 2, and thus the light emission means 11 is capable of emitting the laser light at a freely selected angle θ2. For example, as illustrated in FIG. 4, the angle θ2 is an angle formed between the optical path OP and a reference line L that is set on the x-y plane. The first point cloud data acquisition means 21 is capable of detecting the angle θ2 with a gyro sensor or the like, which is not illustrated.

The first point cloud data acquisition means 21 acquires a difference between the x-coordinate of the light input/output end OI and the x-coordinate of the reflection point RP (D2 in FIG. 4) by multiplying a length of the line segment D1 by sin θ2. Further, the first point cloud data acquisition means 21 acquires a difference between the y-coordinate of the light input/output end OI and the y-coordinate of the reflection point RP (D3 in FIG. 4) by multiplying the length of the line segment D1 with cos θ2. With this, the first point cloud data acquisition means 21 acquires an x-axis relative position and a y-axis relative position of the reflection point RP with respect to the light input/output end OL The first point cloud data acquisition means 21 stores the acquired relative positions on the axes in association with the angle θ1 and the angle θ2.

The light source unit 10 changes at least one of the angle θ1 and the angle θ2, and thus the laser light enters the reflection points RP at different positions. The light source unit 10 emits the laser light according to the plurality of angles θ1 and the plurality of angles θ2 that are determined in advance, and thus receives the reflected laser light from the plurality of reflection points RP in the first region 300. With this, the first point cloud data acquisition means 21 is capable of acquiring the relative positions on the axes for each of the plurality of reflection points RP in the first region 300. The first point cloud data acquisition means 21 generates point cloud data by plotting the plurality of reflection points RP on the three-dimensional model, based on the relative positions of the reflection points RP with respect to the light input/output end OI.

The first point cloud data acquisition means 21 generates the first point cloud data by the above-mentioned method. On this occasion, the first point cloud data acquisition means 21 generates the first point cloud data, based on the first laser reflection light emitted into the first region 300. The first object 410 and the second object 420 are arranged in the first region 300, and hence the first point cloud data acquisition means 21 acquires the first point cloud data associated with the first object 410 and the second object 420.

The region specification means 22 specifies a second region 500 associated with the first object 410 in the first region 300, by using the first point cloud data. The region specification means 22 includes reference point cloud data being point cloud data associated with a shape of the first object 410. In the first point cloud data, the region specification means 22 specifies, as the second region 500, a region with a shape matching with the reference point cloud data. For example, when the first object 410 is a track of a railway line, the region specification means 22 stores point cloud data indicating a shape of an H-shaped steel material used for the railway line, in advance as the reference point cloud data. Note that, in the first point cloud data, the region specification means 22 may specify a region having a similar shape at a certain degree as the second region 500, instead of a region having a shape that completely matches with the reference point cloud data.

The region specification means 22 acquires, from the first point cloud data acquisition means 21, a range of the angle θ1 and a range of the angle θ2 that are associated with the plurality of reflection points RP included in the second region 500, and outputs the acquired ranges to the second point cloud data acquisition means 23.

The second point cloud data acquisition means 23 instructs the light emission means 11 to emit second laser light to a plurality of second positions included in the second region 500. Specifically, the second point cloud data acquisition means 23 tilts the light source unit 10 within the ranges of the angle θ1 and the angle θ2 associated with the reflection point RP included in the second region 500. With this, the light source unit 10 emits the laser light into the second region 500 associated with the first object 410 in the first region 300. As described above, the light emission means 11 emits the second laser light to the plurality of second positions associated with the second region 500.

Moreover, the light reception means 13 receives second laser reflection light being reflection light of the second laser light. The second point cloud data acquisition means 23 acquires second point cloud data associated with the first object 410, based on the second laser reflection light. The second point cloud data acquisition means 23 acquires the second point cloud data by a method similar to the method by which the first point cloud data acquisition means 21 acquires the first point cloud data.

As described above, when the first object 410 is a track of a railway line, and the second object 420 is a roadbed of the railway line, the first object 410 is deformed more easily than the second object 420. According to the optical sensing device 1, the second point cloud data acquisition means 23 is capable of acquiring the second point cloud data generated based on the laser reflection light that is reflected in the second region 500 associated with the first object 410. Thus, the optical sensing device 1 is capable of monitoring the first object 410 with priority over the second object 420, based on the second point cloud data.

Note that an angle at which the light source unit 10 is tilted per unit time in a case of emitting the laser light into the second region 500 is preferably smaller than an angle at which the light source unit 10 is tilted per unit time in a case of emitting the laser light into the first region 300. In this case, a distance between the second positions is smaller than a distance between the first positions. Thus, the second point cloud data acquisition means 23 is capable of acquiring the second point cloud data that are more accurate than the first point cloud data acquired by the first point cloud data acquisition means 21.

The first abnormality detection means 24 detects abnormality of the first object 410, by using the second point cloud data. For example, the first abnormality detection means 24 compares second point cloud data A acquired by the second point cloud data acquisition means 23 during a first period and second point cloud data B acquired during a second period after the first period, with each other. When a difference between the second point cloud data A and the second point cloud data B exceeds a threshold value, the first abnormality detection means 24 detects abnormality of the first object 410.

Next, with reference to FIG. 5, an operation example of the optical sensing device 1 is described.

The light source unit 10 adjusts an emission angle of the laser light (S101). For example, the light source unit 10 adjusts the angle θ1 illustrated in FIG. 3 and the angle θ2 illustrated in FIG. 4 to a predetermined angle.

The light emission means 11 of the light source unit 10 emits the laser light (S102). With this, the laser light is reflected at the reflection point RP in the first region 300.

The light reception means 13 of the light source unit 10 receives the laser reflection light (S103). On this occasion a memory included in the control unit 20, which is not illustrated, stores the time t from emission of the laser light to reception of the reflected laser light, in association with the emission angle of the laser light. Note that, on this occasion, the light source unit 10 may also store intensity of the reflected laser light in addition to the time t.

The light source unit 10 determines whether the laser light is emitted within a predetermined angle range (S104).

When the laser light is not emitted within the predetermined angle range (No in S104), the light source unit 10 adjusts the emission angle of the laser light (S101). For example, the light source unit 10 changes at least one of the angle θ1 illustrated in FIG. 3 and the angle θ2 illustrated in FIG. 4.

When the laser light is emitted within the predetermined angle range (Yes in S104), the first point cloud data acquisition means 21 acquires the point cloud data (S105). Specifically, the first point cloud data acquisition means 21 generates the first point cloud data by the above-mentioned method.

The region specification means 22 specifies the second region 500 associated with the first object 410 in the first region 300, by using the first point cloud data (S106). For example, in the first point cloud data, the region specification means 22 specifies the region with a shape matching with the reference point cloud data, as the second region 500. On this occasion, the region specification means 22 acquires, from the first point cloud data acquisition means 21, the range of the angle θ1 and the range of the angle θ2 that are associated with the plurality of reflection points RP included in the second region 500, and outputs the acquired ranges to the second point cloud data acquisition means 23.

The second point cloud data acquisition means 23 causes the light source unit 10 to execute the processing in S101 to S103 (S107). The second point cloud data acquisition means 23 determines whether the laser light is emitted within the range of the angle associated with the second region 500 (S108).

When the laser light is not emitted within the predetermined angle range (No in S108), the light source unit 10 adjusts the emission angle of the laser light and executes the processing in S107. For example, the light source unit 10 changes at least one of the angle θ1 and the angle θ2 within the range associated with the second region 500.

When the laser light is emitted within the range associated with the second region 500 (Yes in S108), the second point cloud data acquisition means 23 acquires the second point cloud data (S109). Specifically, the second point cloud data acquisition means 23 acquires the second point cloud data by a method similar to the method by which the first point cloud data acquisition means 21 acquires the first point cloud data.

The second point cloud data acquisition means 23 determines whether a predetermined time elapses (S110). The predetermined time is, for example, ten minutes. When the predetermined time elapses, the second point cloud data acquisition means 23 in the optical sensing device 1 executes the processing in S107 to S109 (S111).

The first abnormality detection means 24 compares the second point cloud data acquired through the processing in S109 and the second point cloud data acquired through the processing in S111, with each other, and determines presence or absence of abnormality of the first object 410 (S112). When the difference between the two pieces of the second point cloud data exceeds the threshold value, the first abnormality detection means 24 determines that abnormality occurs to the first object 410. Further, when the difference between the two pieces of the second point cloud data does not exceed the threshold value, the first abnormality detection means 24 determines that abnormality does not occur to the first object 410.

As described above, the optical sensing device 1 includes the light emission means 11, the light reception means 13, the first point cloud data acquisition means 21, the region specification means 22, the second point cloud data acquisition means 23, and the first abnormality detection means 24. The light emission means 11 emits the first laser light to the plurality of first positions in the first region 300. The light reception means 13 receives the first laser reflection light being reflection light of the first laser light. The first point cloud data acquisition means 21 acquires the first point cloud data associated with the first object 410 and the second object 420 that are included in the first region 300, based on the first laser reflection light. The region specification means 22 specifies the second region 500 associated with the first object 410 in the first region 300, by using the first point cloud data. The light emission means 11 further emits the second laser light to the plurality of second positions associated with the second region. The light reception means 13 receives the second laser reflection light being reflection light of the second laser light. The second point cloud data acquisition means 23 acquires the second point cloud data associated with the first object 410, based on the second laser reflection light. The first abnormality detection means 24 detects abnormality of the first object 410, by using the second point cloud data.

As described above, in the optical sensing device 1, the first abnormality detection means 24 uses the second point cloud data associated with the first object 410 being an inspection target in the first region 300 in order to detect abnormality of the first object. The second point cloud data are data having a data amount smaller than the first point cloud data associated with the first region 300. Thus, the optical sensing device 1 is capable of detecting abnormality of an inspection target more efficiently as compared to a case in which the first point cloud data are used.

Note that, in the optical sensing device 1 described above, the light source unit 10 and the control unit 20 are separately provided. However, those units are not necessarily required to be provided separately. For example, the optical sensing device 1 may be an optical sensing device in which the light source unit 10 and the control unit 20 are provided in an integrated manner.

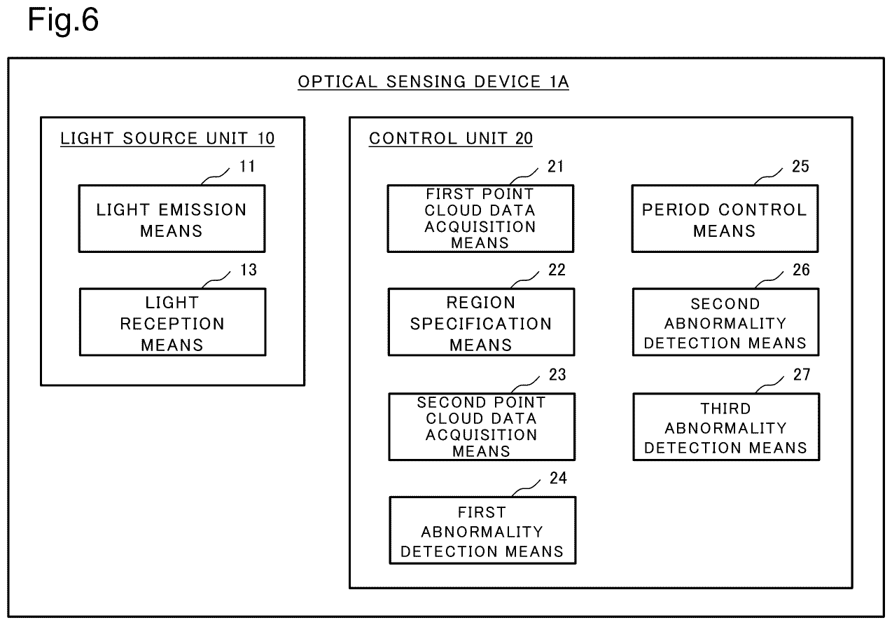

Next, with reference to FIG. 6, an optical sensing device 1A is described. The optical sensing device 1A is a modification example of the optical sensing device 1. As illustrated in FIG. 6, the optical sensing device 1A is different from the optical sensing device 1 in that the control unit 20 includes a period control means 25, a second abnormality detection means 26, and a third abnormality detection means 27.

The period control means 25 causes the light source unit 10 to emit the first laser light and the second laser light during a second period other than a first period during which a vehicle passes on a railway line (the first object 410). Specifically, the period control means 25 stores in advance the first period during which the vehicle such as a train passes on the railway line being the first object 410. The period control means 25 instructs the light source unit 10 to execute the processing in S101 to S103, the processing in S107, and the processing in S111 during the second period other than the above-mentioned the first period.

When the light emission means 11 emits the laser light into the second region 500 while the vehicle passes on the railway line being the first object 410, it is difficult for the optical sensing device 1 to acquire the second point cloud data accurately indicating the shape of the first object 410. In contrast, in the optical sensing device 1A, the period control means 25 enables emission of the laser light during the second period other than the first period during which the vehicle passes on the railway line (the first object 410), and hence the second point cloud data accurately indicating the shape of the first object 410 can be acquired.

The second abnormality detection means 26 detects abnormality of the second object 420, by using the first point cloud data. In this case, the optical sensing device 1A executes the processing in S101 to S112 at least twice.

The second abnormality detection means 26 specifies a third region 600 associated with the second object 420 in the first region 300, by using the first point cloud data. The second abnormality detection means 26 includes second reference point cloud data being point cloud data associated with a shape of the second object 420. In the first point cloud data, the second abnormality detection means 26 specifies a region with a shape matching with the second reference point cloud data, as the third region 600.

For example, when the second object 420 is a roadbed of the railway line, the second abnormality detection means 26 stores point cloud data indicating a shape of a wood material used for the roadbed of the railway line, in advance as the second reference point cloud data. Note that, in the first point cloud data, the second abnormality detection means 26 may specify a region having a similar shape at a certain degree as the third region 600, instead of a region having a shape that completely matches with the second reference point cloud data.

The second abnormality detection means 26 compares first point cloud data A acquired through the first processing in S105 and first point cloud data B acquired through the second processing in S105 with each other, and thus detects a change amount of the portion specified as the third region 600. When the detected change amount exceeds a threshold value, the second abnormality detection means 26 detects abnormality of the second object 420.

The third abnormality detection means 27 detects abnormality of the first object 410, by using the first point cloud data. In this case, the optical sensing device 1A executes the processing in S101 to S112 at least twice.

Through the processing in S106, the region specification means 22 specifies the second region 500 associated with the first object 410 in the first region 300, by using the first point cloud data.

The third abnormality detection means 27 compares the first point cloud data A acquired through the first processing in S105 and the first point cloud data B acquired through the second processing in S105 with each other, and thus detects a change amount of the portion specified as the second region 500. When the detected change amount exceeds a threshold value, the third abnormality detection means 27 detects abnormality of the first object 410.

### Second Example Embodiment

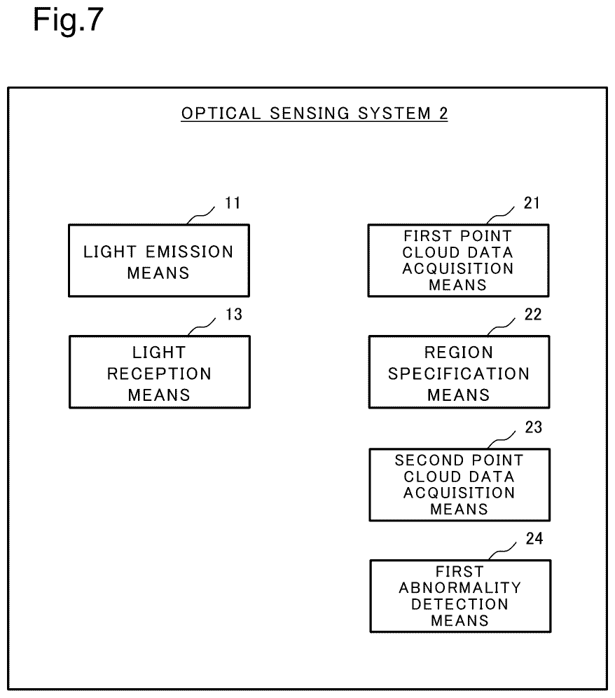

With reference to FIG. 7, an optical sensing system 2 according to a second example embodiment is described. FIG. 7 is a block diagram illustrating a configuration example of the optical sensing system 2.

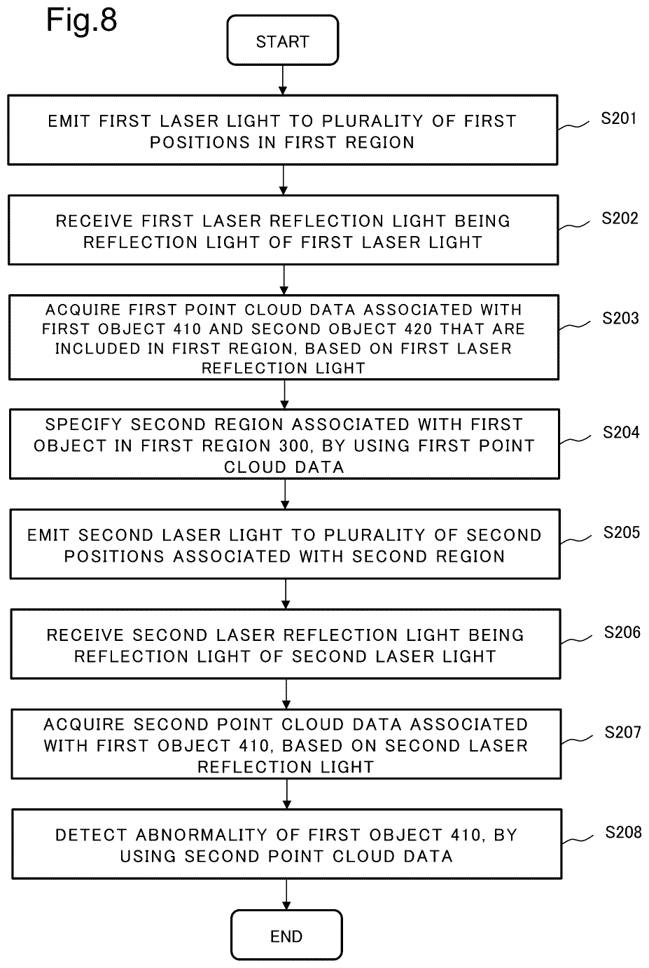

A configuration of the optical sensing system 2 is described. As illustrated in FIG. 8, the optical sensing system 2 includes a light emission means 11, a light reception means 13, a first point cloud data acquisition means 21, a region specification means 22, a second point cloud data acquisition means 23, and a first abnormality detection means 24.

The light emission means 11 emits first laser light to a plurality of first positions in a first region. The light reception means 13 receives first laser reflection light being reflection light of the laser light.

The first point cloud data acquisition means 21 acquires first point cloud data associated with a first object 410 and a second object 420 that are included in the first region, based on the first laser reflection light.

The region specification means 22 specifies a second region associated with the first object in a first region 300, by using the first point cloud data.

The light emission means 11 further emits second laser light to a plurality of second positions associated with the second region. The light reception means 13 receives second laser reflection light being reflection light of the second laser light.

The second point cloud data acquisition means 23 acquires second point cloud data associated with the first object 410, based on the second laser reflection light.

The first abnormality detection means 24 detects abnormality of the first object 410, based on the second point cloud data.

Next, with reference to FIG. 8, an operation of the optical sensing system 2 is described. FIG. 8 is a flowchart illustrating an operation of the optical sensing system 2. Note that a program may cause an information processing device to execute an optical sensing method illustrated in this flowchart.

The light emission means 11 emits first laser light to a plurality of first positions in a first region (S201). The light reception means 13 receives first laser reflection light being reflection light of the first laser light (S202).

The first point cloud data acquisition means 21 acquires first point cloud data associated with a first object 410 and a second object 420 that are included in the first region, based on the first laser reflection light (S203).

The region specification means 22 specifies second region associated with the first object in the first region 300, by using the first point cloud data (S204).

The light emission means 11 further emits second laser light to a plurality of second positions associated with the second region (S205). The light reception means 13 receives second laser reflection light being reflection light of the second laser light (S206).

The second point cloud data acquisition means 23 acquires second point cloud data associated with the first object 410, based on the second laser reflection light (S207).

The first abnormality detection means 24 detects abnormality of the first object 410, by using the second point cloud data (S208).

As described above, in the optical sensing system 2, the first abnormality detection means 24 uses the second point cloud data associated with the first object 410 being an inspection target in the first region in order to detect abnormality of the first object. The second point cloud data are data having a data amount smaller than the first point cloud data associated with the first region. Thus, the optical sensing system 2 is capable of detecting abnormality of an inspection target more efficiently as compared to a case in which the first point cloud data are used.

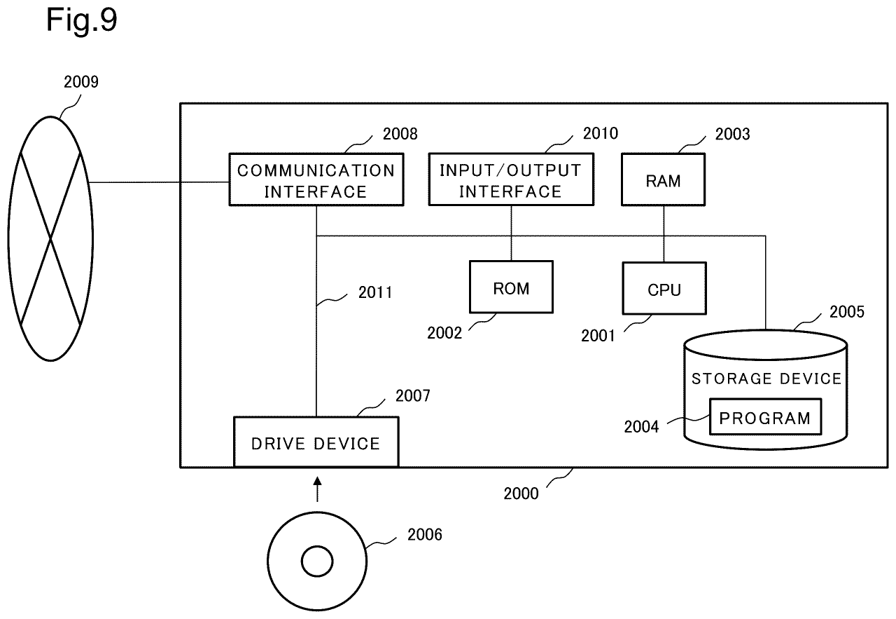

Further, some or all of the components of each of the devices or the system is achieved by any combination of an information processing device 2000 and a program, as illustrated in FIG. 9, for example. FIG. 9 is a diagram illustrating an example of an information processing device for achieving the optical sensing device 1, the optical sensing system 2, and the like. As an example, the information processing device 2000 includes the following configuration.
A central processing unit (CPU) 2001
A read only memory (ROM) 2002
A random access memory (RAM) 2003
A program 2004 loaded on the RAM 2003
A storage device 2005 that stores the program 2004
A drive device 2007 that performs writing and reading of a recording medium 2006
A communication interface 2008 that is connected to a communication network 2009
An input/output interface 2010 that inputs and outputs data
A bus 2011 that connects each component

Each of the components of each of the devices in each of the example embodiments is achieved by the CPU 2001 acquiring and executing the program 2004 for achieving those functions. For example, the program 2004 for achieving functions of the components of each of the devices is stored in the storage device 2005 or the RAM 2003 in advance, and is read out by the CPU 2001, as required. The program 2004 may be supplied to the CPU 2001 via the communication network 2009, or may be stored in advance in the recording medium 2006, and may be supplied to the CPU 2001 by the drive device 2007 reading out the program.

Various modification examples are given as a method of achieving each of the devices. For example, each of the devices may be achieved by any combinations of a program and the information processing device 2000, each of which is separately provided for each of the components. Further, a plurality of components to be included in each of the devices may be achieved by any one combination of a program and the information processing device 2000.

Further, a part or an entirety of each of the components of each of the devices is achieved by a general or dedicated circuitry including a processor or the like, or by a combination thereof. These may be configured by a single chip or a plurality of chips connected to each other via a bus. A part or an entirety of each of the components of each of the devices may be achieved by a combination of the circuitry or the like described above and a program.

When a part or an entirety of each of the components of each of the devices is achieved by a plurality of information processing devices, circuitries, and the like, the plurality of information processing devices, the circuitries, and the like may be arranged in a centralized way, or may be arranged in a distributed way. For example, the information processing devices, the circuitries, and the like may be achieved in a form in which each of the information processing devices, the circuitries, and the like is connected via a communication network, such as a client-and-server system and a cloud computing system.

While the disclosure has been particularly shown and described with reference to example embodiments thereof, the disclosure is not limited to these embodiments. It will be understood by those of ordinary skill in the art that various changes in form and details may be made therein without departing from the spirit and scope of the present disclosure as defined by the claims.

1. An optical sensing device comprising:
a first point cloud data acquirer configured to acquire first point cloud data associated with a first object and a second object that are included in a first region, based on first laser reflection light being reflection light of first laser light emitted from a light source configured to emit laser light to a plurality of first positions in the first region;
a region specifier configured to specify a second region associated with the first object in the first region, by using the first point cloud data;
a second point cloud data acquirer configured to acquire second point cloud data associated with the first object by emitting second laser light from the light source to a plurality of second positions associated with the second region, based on second laser reflection light being reflection light of the second laser light; and
a first abnormality detector configured to detect abnormality of the first object, by using the second point cloud data.

2. The optical sensing device according to claim 1, wherein a distance between the second positions is smaller than a distance between the first positions.

3. The optical sensing device according to claim 1, wherein the light source is attached to a stationary object.

4. The optical sensing device according to claim 1, wherein
the first object includes a track of a railway line, and
the second object includes a roadbed of the railway line.

5. The optical sensing device according to claim 4, further comprising
a period controller configured to cause the light source to emit the first laser light and the second laser light during a second period other than a first period during which a vehicle passes on the railway line.

6. The optical sensing device according to claim 1, further comprising
a second abnormality detector configured to detect abnormality of the second object, by using the first point cloud data.

7. The optical sensing device according to claim 1, further comprising
a third abnormality detector configured to detect abnormality of the first object, by using the first point cloud data.

8. The optical sensing device according to claim 1, wherein the light source includes:
a light emitter configured to emit the first laser light or the second laser light; and
a light receiver configured to receive the first laser reflection light or the second laser reflection light.

9. An optical sensing system comprising:
a light emitter configured to emit first laser light to a plurality of first positions in a first region;
a light receiver configured to receive first laser reflection light being reflection light of the first laser light;
a first point cloud data acquirer configured to acquire first point cloud data associated with a first object and a second object that are included in the first region, based on the first laser reflection light;
a region specificator configured to specify a second region associated with the first object in the first region, by using the first point cloud data;
a second point cloud data acquirer; and
a first abnormality detector, wherein
the light emitter emits second laser light to a plurality of second positions associated with the second region,
the light receiver receives second laser reflection light being reflection light of the second laser light,
the second point cloud data acquirer acquires second point cloud data associated with the first object, based on the second laser reflection light, and
the first abnormality detector detects abnormality of the first object, by using the second point cloud data.

10. The optical sensing system according to claim 9, wherein a distance between the second positions is smaller than a distance between the first positions.

11. The optical sensing system according to claim 9, wherein the light emitter and the light receiver are attached to a stationary object.

12. The optical sensing system according to claim 9, wherein
the first object includes a track of a railway line, and
the second object includes a roadbed of the railway line.

13. The optical sensing system according to claim 12, further comprising
a period controller configured to cause the light emitter to emit the first laser light and the second laser light during a second period other than a first period during which a vehicle passes on the railway line.

14. The optical sensing system according to claim 9, further comprising
a second abnormality detector configured to detect abnormality of the second object, by using the first point cloud data.

15. The optical sensing system according to claim 9, further comprising
a third abnormality detector configured to detect abnormality of the first object, by using the first point cloud data.

16. An optical sensing method comprising:
emitting first laser light to a plurality of first positions in a first region;
receiving first laser reflection light being reflection light of the first laser light;
acquiring first point cloud data associated with a first object and a second object that are included in the first region, based on the first laser reflection light;
specifying a second region associated with the first object in the first region, by using the first point cloud data;
emitting second laser light to a plurality of second positions associated with the second region;
receiving second laser reflection light being reflection light of the second laser light;
acquiring second point cloud data associated with the first object, based on the second laser reflection light; and
detecting abnormality of the first object, by using the second point cloud data.

17. The optical sensing method according to claim 16, wherein a distance between the second positions is smaller than a distance between the first positions.

18. The optical sensing method according to claim 16, wherein
the first object includes a track of a railway line, and
the second object includes a roadbed of the railway line.

19. The optical sensing method according to claim 18, further comprising
causing the light emitter to emit the first laser light and the second laser light during a second period other than a first period during which a vehicle passes on the railway line.

20. The optical sensing method according to claim 16, further comprising
detecting abnormality of the second object, by using the first point cloud data.

21. The optical sensing method according to claim 16, further comprising
detecting abnormality of the first object, by using the first point cloud data.
